(19) United States
(12) Patent Application Publication
(10) Pub. No.: US 2018/0025344 A1
(43) Pub. Date: Jan. 25, 2018

(54) COMMUNICATING AUTHENTICATION INFORMATION BETWEEN MOBILE DEVICES

(71) Applicant: CA, Inc., New York, NY (US)

(72) Inventors: Sharath Kumar L., Bangalore (IN); Mohammed Mujeeb Kaladgi, Bangalore (IN); Rajdeep Lahkar, Bangalore (IN); Pradeep G. Nair, Bangalore (IN); Mahesh M. Chitragar, Bangalore (IN)

(21) Appl. No.: 15/218,997

(22) Filed: Jul. 25, 2016

(51) Int. Cl. G06Q 20/32

(52) U.S. Cl. CPC G06Q 20/3229; G06Q 20/327

(57) ABSTRACT

Techniques are disclosed relating to authentication for user transactions. In some embodiments, a first device of the user provides an option for the user to transfer payment and device signature information to a second device of the user. The second device, in some embodiments, then uses the payment information for payment transactions (which may avoid manual input of payment information). The second device, in some embodiments, transmits the device signature information for the first device to an authentication system. The authentication system, in some embodiments, authenticates the second device based on a match for the signature information for the first device.

### BACKGROUND

### Technical Field

This disclosure relates generally to user authentication and more particularly to sharing device signature information between mobile devices.

### Description of the Related Art

Mobile computing devices are increasingly being used for payment transactions. Security is important for payment transactions, for example, to prevent unauthorized individuals from intercepting payment information. Therefore, before moving payment data to a new device, the user of the new device may need to perform authentication (e.g., using a one-time password (OTP)), enter payment card details, answer security questions, enter a CVV number for each payment instrument, and/or setup a personal identification number (PIN).

### SUMMARY

Techniques are disclosed relating to authentication for user transactions. In some embodiments, a first device of the user provides an option for the user to transfer payment and device signature information to a second device of the user. The second device, in some embodiments, then uses the payment information for payment transactions (which may avoid manual input of payment information). The second device, in some embodiments, transmits the device signature information for the first device to an authentication system. The authentication system, in some embodiments, authenticates the second device based on a match for the signature information for the first device.

The device signature information may be based on hardware elements and/or software of the first device. The second device may also send device signature information for the second device to the authentication system, which may be used for future authentications of the second device. The payment information may include transaction account numbers, user preferences, previous transaction information, etc. The first device may gather the payment information into a single file prior to transmitting the payment information to the second device.

### BRIEF DESCRIPTION OF THE DRAWINGS

FIG. 1A is a block diagram illustrating an exemplary computing system that includes wireless connections for communicating between an authentication system and multiple mobile devices as well as between the mobile devices, according to some embodiments.

FIG. 1B is a block diagram illustrating exemplary techniques for sharing authentication information between mobile devices in the system of FIG. 1A, according to some embodiments.

FIG. 2 is a diagram illustrating exemplary techniques for generating device signature information, according to some embodiments.

FIG. 3 is a flow diagram illustrating an exemplary method.

FIG. 4 is a flow diagram illustrating an exemplary server-side method for authenticating a device, according to some embodiments.

FIG. 5 is a flow diagram illustrating an exemplary method for sending authentication information to another device, according to some embodiments.

FIG. 6 is a flow diagram illustrating an exemplary method for receiving authentication information from another device, according to some embodiments.

FIG. 7 is a block diagram illustrating an exemplary device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “mobile device configured to determine device signature information” is intended to cover, for example, a mobile device that performs this function during operation, even if the device in question is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. §112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

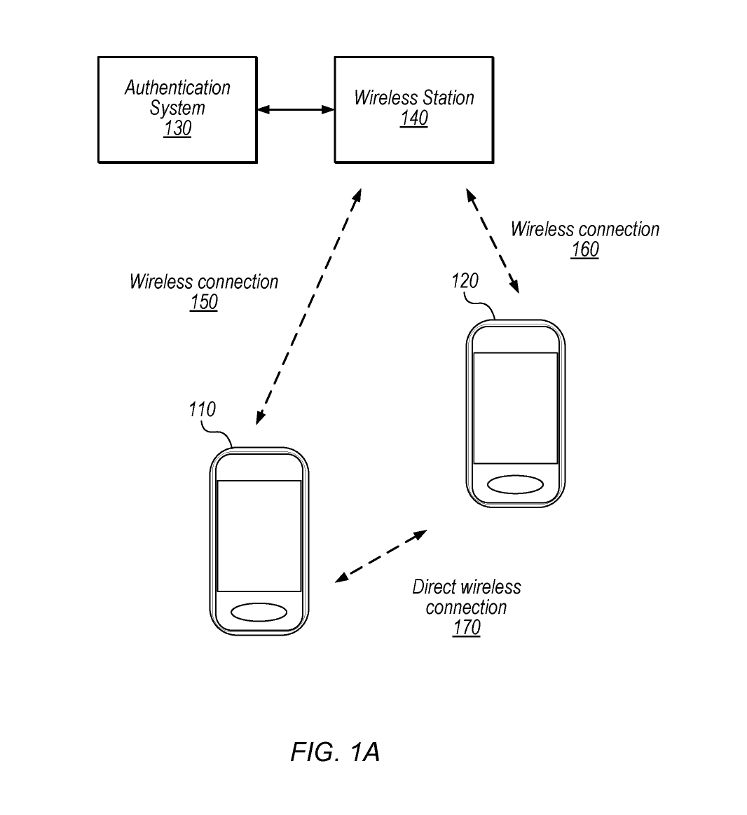

FIG. 1A is a diagram illustrating an exemplary system that includes multiple mobile devices 110 and 120, an authentication system 130, and a wireless station 140, according to some embodiments. In some embodiments, mobile device 120 is configured to send payment and authentication information (e.g., device signature information) to mobile device 110 to facilitate authentication of mobile device 120. This may avoid a need for the user to manually enter certain types of authentication information.

In some embodiments, authentication system 130 is configured to verify the identify of users prior to allowing the users to perform transactions. In the illustrated embodiment, mobile devices 110 and 120 are configured to communicate with the authentication system 130 via wireless station 140 using wireless connections 150 and 160. Wireless station 140 may be any of various appropriate elements such as a cellular base station or a WiFi access point, for example. Various intervening systems (not shown) such as a cellular carrier network or the Internet may be implemented between wireless station 140 and authentication system 130 to facilitate communications. Wireless connection 150 and 160 may use the same protocol or may use different protocols. For example, both connections may be cellular, one may be cellular and one may be WLAN, etc. Wireless connections 150 and 160 may be limited in duration and may be replaced with other wireless connections as appropriate (e.g., to a new wireless station when a mobile device moves outside of the coverage of wireless station 140).

In the illustrated embodiment, mobile devices 110 and 120 are configured to communicate with each other via a direct wireless connection 170. These devices may also be configured to communicate via non-direct connections (e.g., via wireless station 140 using text messaging or voice calls). As used herein, a “direct” connection is one that does not use any intermediate network elements for the communication. For example, communications between mobile devices via a cellular network are not direct because they occur via a cellular base station element. In contrast, WiFi Direct, near field communication (NFC), and Bluetooth® connections, for example, are typically direct connections between mobile devices that do not use any intermediate network element. In some embodiments, using a direct connection to transfer payment data and authentication data may enhance security of user data.

In some embodiments, direct wireless connection 170 is a short-range connection such that mobile devices 110 and 120 must be relatively near one another (e.g., within 100 meters, 40 meters, 10 meters, 1 meter, 2 centimeters, etc., in different embodiments). This may further increase security of transferred information by ensuring that both parties are in close proximity. In some embodiments (not shown), wireless connection 170 may be a short-range connection, e.g., via a short-range access point without being a direct connection. In some embodiments, device 120 is configured to verify that device 110 is within a particular range of device 120 before sending payment information and authentication information. This may be performed using signal strength measurements, satellite navigation, triangulation of cell tower, combinations of such techniques, etc. This may prevent unauthorized individuals from receiving payment information. In some embodiments, the device 110 and 120 may actually need to make physical contact in order to perform the transmission, e.g., in order to improve signal quality and/or to verify proximity of the devices.

FIG. 1B is a diagram illustrating an exemplary sequence of transmissions between elements of the system of FIG. 1A, according to some embodiments.

At point (1), in the illustrated embodiment, device 120 performs device-signature-based authentication. In the illustrated example, device 120 is referred to as an “old” device and device 110 is referred to as a “new” device. In some embodiments, device 120 is an old device of a user and device 110 is a newly purchased device of the user. Therefore, the labels “old” and “new” may be helpful for explanation. In other embodiments, however, device 110 may not actually be a new device for the user. For example, the user may use both devices but at different times (e.g., one device may be a wearable and the other device a mobile phone). As another example, device 110 may be a device of another user with which a user of device 120 shares payment information (e.g., for a short duration). Therefore, the terms “old” and “new” are used for illustrative purposes but are not intended to limit the scope of the present disclosure.

Mobile devices 110 and 120, in various embodiments, are configured to generate device signature information based on various device characteristics. In some embodiments, device 120 generates device signature information based on both hardware components included in device 120 (e.g., component serial numbers, keys, model numbers, manufacturer identification, MAC addresses, etc.), software installed on device 120 (e.g., user applications, operating system version), etc. In some embodiments, the device signature information is generated based on hardware components and not software modules or vice versa. In some embodiments, device signature information is generated based on a private key stored on the generating device. In some embodiments, device 120 uses a hashing function that uses this various information as an input and generates a device signature for device 120. In various embodiments, the device signature information is generated such that it is unlikely that another device would generate the same device signature.

Device-signature-based authentication of device 120 by authentication system 130 may involve device 120 generating a device signature and transmitting the device signature to authentication system 130. In some embodiments, authentication system 130 then compares the received device signature with a previously-received device signature for device 120. If the signatures meets certain specified criteria, authentication system 130 sends an authentication confirmation to device 120. In some embodiments, authentication system 130 is configured to determine that there is a “match” between device signature information in some situations even if two device signatures are not exactly the same. For example, authentication system 130 may confirm the identity of device 120 if the two signatures do not differ more than some threshold amount. In some embodiments, this procedure may allow a user to change a certain amount of the software and/or hardware installed on device 120 without inhibiting signature-based authentication, for example. Thus, a device's signature may be based on the current characteristics on the mobile device allowing a signature to change over time.

At point (2), in the illustrated embodiment, device 120 transfers payment information and device signature information to device 110. The payment information may include, without limitation: payment keys, tokens, card details, transaction logs, user settings, etc. Device 120 may send the device signature information with other authentication information that includes additional authentication credentials.

In some embodiments, mobile device 120 is configured to execute a mobile payment application that stores data in multiple locations (which may include multiple types of storage hardware and/or multiple types of data structures). For example, in some embodiments, data is stored in preferences that are shared among applications of a mobile device, internal device storage, and/or a database structure (e.g., a SQLite database). In some embodiments, device 120 is configured to collate this information into a single file and send the file to device 110 via the direct wireless connection 170.

At point (3), in the illustrated embodiment, mobile device 110 and authentication system 130 perform an initial authentication procedure that uses the device signature information from mobile device 120. For example, in some embodiments mobile device 110 sends both the device signature information for device 120 and newly determined device signature information for itself. In some embodiments, authentication system 130 determines whether the device signature information for device 120 matches stored device signature information for device 120. If there is a match, authentication system 130 may store the device signature information for device 110 and associate it with an account of the user so that subsequent authentications will determine whether there is a match between the stored device signature information for device 110 and device signature information received in authentication requests. (Again, a “match” may either constitute an exact correspondence of values or a correspondence within some specified degree of similarity).

In some embodiments, the user (or multiple users) are required to login to accounts on one or both of devices 110 and 120 prior to performing the techniques shown in FIG. 1B. In some embodiments, a user logs into an application on device 120 using a password or PIN. In these embodiments, device 120 then generates a one-time password (e.g., using a shared secret that is known the device 120 and the authentication system) and sends it to authentication system 130 for authentication. Once authenticated, the application is configured, in some embodiments, to display a user interface option to send payment data to another device (e.g., device 110). The user may select which payment details are to be sent (e.g., by selecting a particular set of account from among multiple stored payment accounts), and confirm the identity of the receiving device 110. The user may then login to the application on device 110 and perform transactions. In some embodiments, transferring the device signature information between devices may allow for authentication without time-consuming data entry. For example, in some embodiments authentication system 130 authenticates device 110 and/or facilitates payment transactions without requiring a user to enter card details, answer security questions, perform CVV authentication, setup user preferences, setup account login information, etc. Thus, transfer of device signature information may avoid time-consuming authentication and manual entry of data and/or provide additional security for transactions.

In some embodiments, the user interface is configured to display images representing payment cards that the user can swipe toward the target device in order to initiate transfer of card data and device signature information. In some embodiments, the disclosed techniques are used by a first user to loan a payment card to another user, e.g., a friend, for a limited amount of time. In these embodiments, device 120 is configured to notify authentication system 130 that the transfer is occurring and specify a time window in which device 110 is allowed to use the received payment information.

In some embodiments, device 120 notifies authentication system 130 that a transfer of payment data is occurring and a payment server (which may be included in authentication system 130 or may be a separate system) blocks requests from the user until successful authentication of device 110.

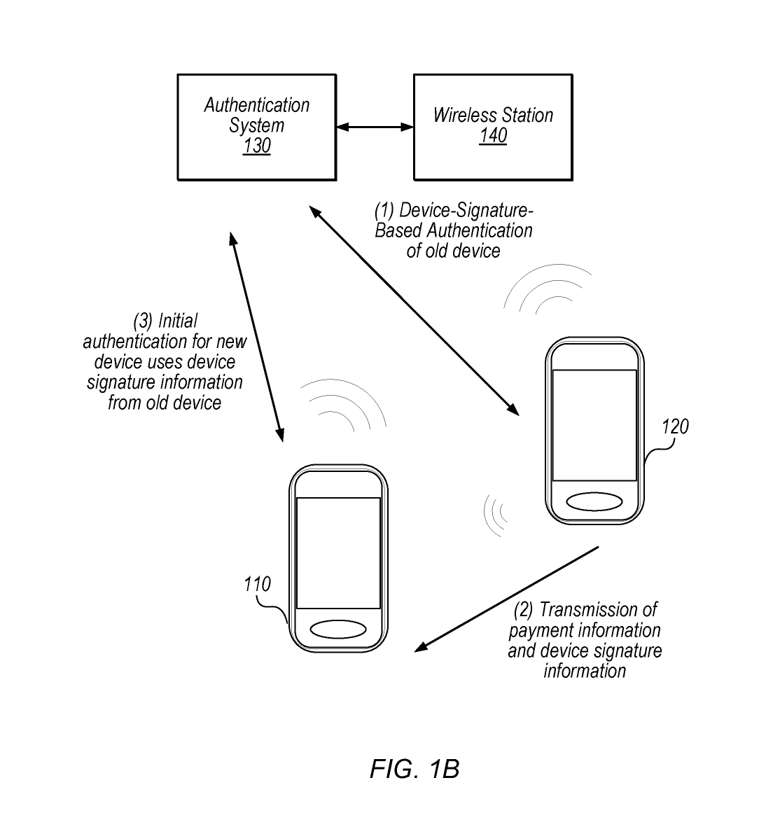

FIG. 2 is a block diagram illustrating exemplary techniques for generating device signature information, according to some embodiments. In the illustrated embodiment, information from hardware component 210, software information 220, and private key information 230 are combined using a hash function 240 to generate device signature information 250. In some embodiments, illustrated inputs to hash function 240 may be omitted and/or additional inputs may be implemented. Private key information 230, in the illustrated embodiment, is an input to the hash function. In other embodiments, however, private key information 230 is used to cryptographically sign an output of hash function 240.

Although device signature information is one example of authentication information that is transferred by one mobile device to another, in some embodiments, the authentication information may also include additional information such as private key information, stored user login information, etc. Therefore, in various embodiments other types of authentication information may be transferred in addition to and/or in place of device signature information.

### Exemplary Methods

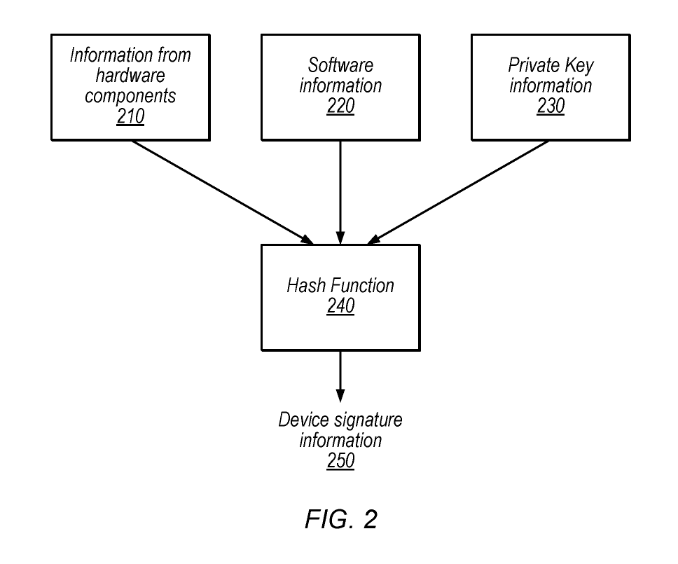

FIG. 3 is a flow diagram illustrating a method 300 for transferring payment and authentication information between devices, according to some embodiments. The method shown in FIG. 3 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 310, in the illustrated embodiment, a first mobile device (e.g., device 120) receives user login information (e.g., a username and password) and a request to transfer account information to a second mobile device (e.g., device 110).

At 320, in the illustrated embodiment, the first mobile device determines device signature information and aggregates payment information. This may include generating a device signature and retrieving payment information from multiple data structures. In some embodiments, the first mobile device is configured not to determine device signature information or aggregate payment information if user login information is incorrect.

At 330, in the illustrated embodiment, the first mobile device transmits payment information and device signature information to the second mobile device via a direct wireless connection. This connection may be an NFC connection or Bluetooth® connection, for example. In some embodiments, device 120 is configured not to transfer device signature information over non-direct wireless connections.

At 340, in the illustrated embodiment, the second mobile device stores the payment information. This may allow the payment information to be used for multiple subsequent transactions. The payment information may include credit card numbers, bank account numbers, online payment account numbers, etc.

At 350, in the illustrated embodiment, the second mobile device transmits device signature information for both the first and second mobile devices to the authentication server. In other embodiments, the second mobile device may transmit only the signature information for the first mobile device, e.g., if the second mobile device will not be used for later transactions.

At 360, in the illustrated embodiment, the authentication server authenticates the second mobile device based on the device signature information for the first mobile device (e.g., based on matching it to stored device signature information for the first mobile device) and login information for the user (e.g., a username and password).

At 370, in the illustrated embodiment, the second mobile device performs one or more transactions for the user using the stored payment information.

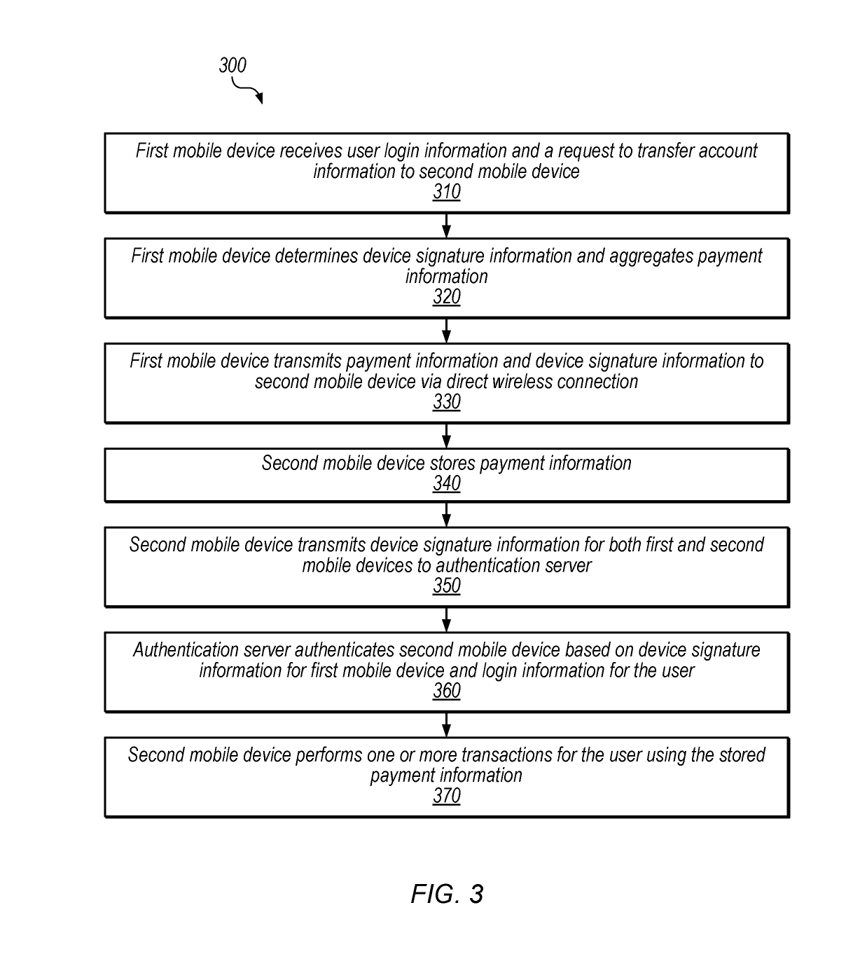

FIG. 4 is a flow diagram illustrating a server-side method 400 for authenticating a mobile device, according to some embodiments. The method shown in FIG. 4 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 410, in the illustrated embodiment, a computing system (e.g., an authentication system, a payment processing system, etc.) stores device signature information for a first mobile device of a user (e.g., device 120). The stored device signature information may have been received previously from the first device and associated with an account of the user.

At 420, in the illustrated embodiment, the computing system receives an authentication request from a second mobile device (e.g., device 110) that includes both device signature information for the first mobile device and device signature information for the second mobile device.

At 430, in the illustrated embodiment, the computing system determines whether the received device signature information for the first mobile device matches the stored device signature information for the first mobile device.

At 440, in the illustrated embodiment, the computing system stores the device signature information for the second mobile device (e.g., based on a determination that there was a match in method element 430) and associates the device signature information for the second mobile device with an account of the user. In the illustrated embodiment, the computing system also authorizes one or more transactions of the user that are initiated using the second mobile device. In some embodiments, the computing system deletes the stored device signature information for the first mobile device after receiving device signature information for the second mobile device. In other embodiments, the computing system is configured to store device signature information for both devices, which may allow the user to perform payment transactions using multiple different devices.

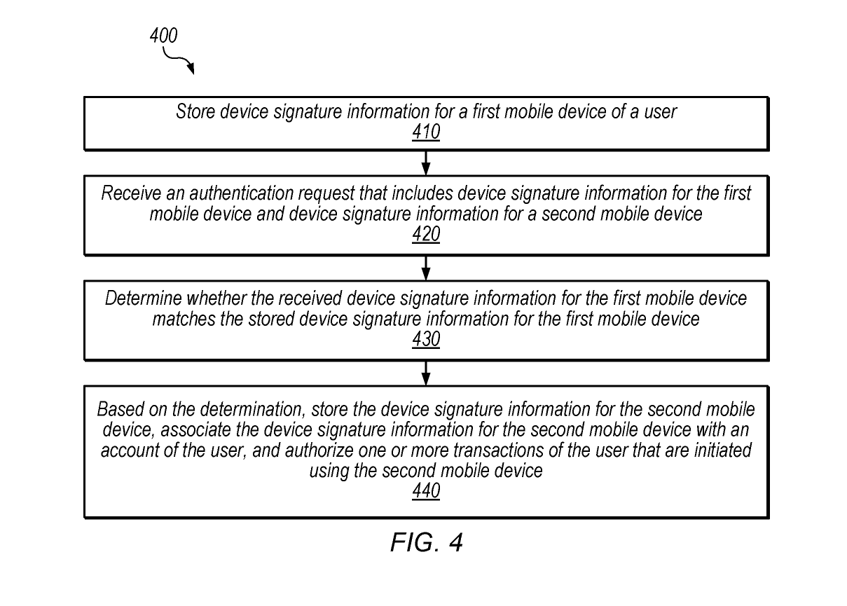

FIG. 5 is a flow diagram illustrating a server-side method 500 for sending payment and authentication information to another mobile device, according to some embodiments. The method shown in FIG. 5 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 510, in the illustrated embodiment, device 120 determines device signature information. This may be performed in response to user input, for example, requesting to transfer payment-related information to device 110. In some embodiments, device 120 requires user login information before determining the device signature information. This may prevent unauthorized users from sending sensitive information to other devices.

At 520, in the illustrated embodiment, device 120 transmits, to mobile device 110 via a direct wireless connection, information for a user. In the illustrated embodiment, the information includes payment information that specifies information for at least one transaction instrument and the device signature information.

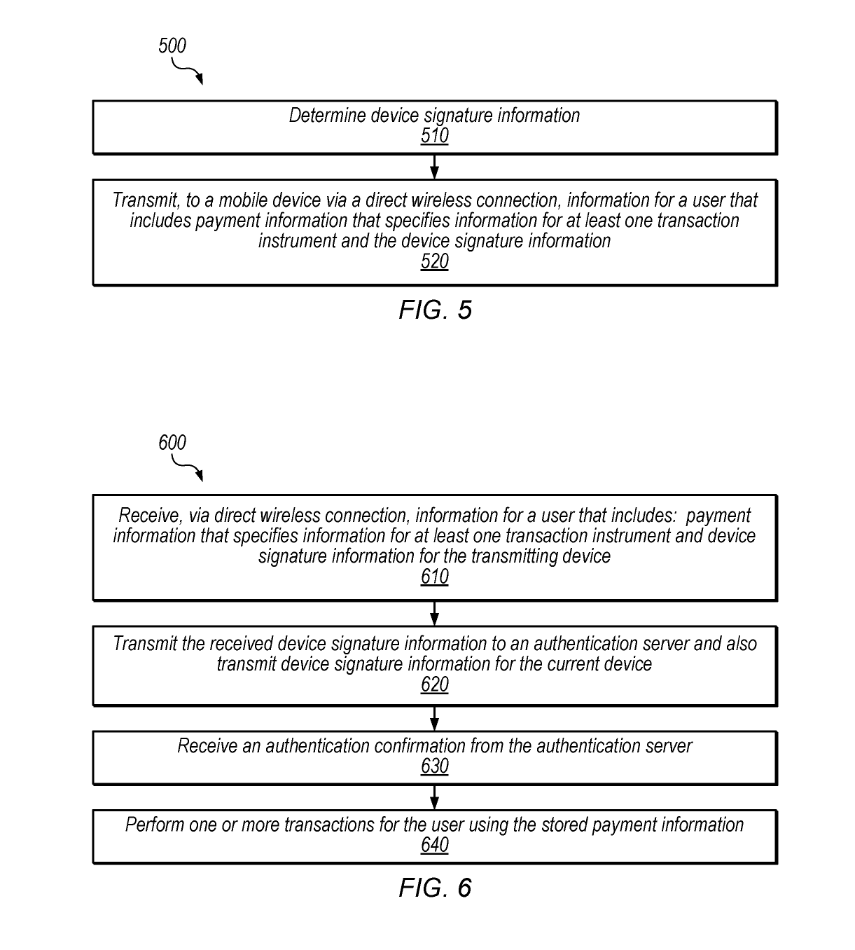

FIG. 6 is a flow diagram illustrating a server-side method 600 for receiving and using payment and authentication information from another mobile device, according to some embodiments. The method shown in FIG. 6 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 610, in the illustrated embodiment, device 110 receives, via a direct wireless connection, information for a user. In the illustrated embodiment the information includes payment information that specifies information for at least one transaction instrument and device signature information that is a signature for the transmitting device.

At 620, in the illustrated embodiment, device 110 transmits the received device signature information to an authentication system and also transmits device signature information for itself.

At 630, in the illustrated embodiment, device 110 receives an authentication confirmation from the authentication system.

At 640, in the illustrated embodiment, device 110 performs one or more transactions for the user using the stored payment information. In some embodiments, subsequent authentication transactions for device 110 are performed based on the authentication system matching transmitted device signature information for device 110. In various embodiments, the transactions for the user are performed without requiring the user to perform one-time password authentication (e.g., using a text message code), enter information for a transaction instrument manually, authenticate using a card verification value (CVV), or answer a security question. In other embodiments, device 110 may require one or more of these authentication factors to increase security. In various embodiments, the disclosed techniques may facilitate transferring payment information to new devices by adding an additional authentication factor and/or allowing omission of other authentication factors.

### Exemplary Device

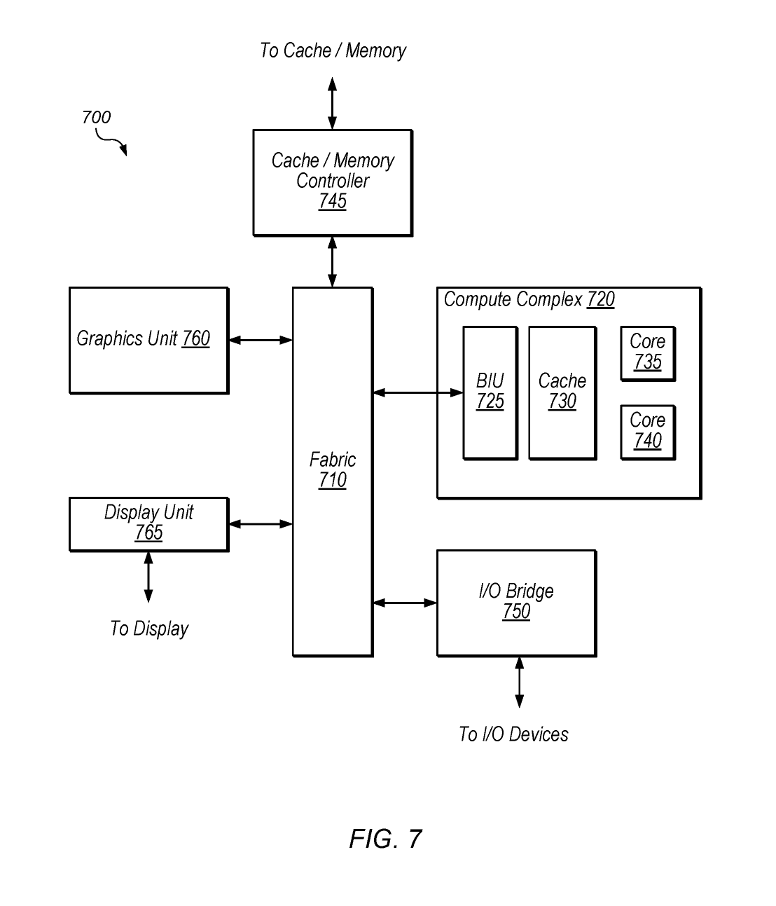

Referring now to FIG. 7, a block diagram illustrating an exemplary embodiment of a device 700 is shown. In some embodiments, elements of device 700 may be included within a system on a chip. In some embodiments, device 700 may be included in a mobile device, which may be battery-powered. Therefore, power consumption by device 700 may be an important design consideration. In the illustrated embodiment, device 700 includes fabric 710, compute complex 720, input/output (I/O) bridge 750, cache/memory controller 745, graphics unit 760, and display unit 765.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and/or caches. For example, compute complex 720 may include 1, 2, or 4 processor cores, or any other suitable number. In one embodiment, cache 730 is a set associative L2 cache. In some embodiments, cores 735 and/or 740 may include internal instruction and/or data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions.

Cache/memory controller 745 may be configured to manage transfer of data between fabric 710 and one or more caches and/or memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches.

As used herein, the term “coupled to” may indicate one or more connections between elements, and a coupling may include intervening elements. For example, in FIG. 7, graphics unit 760 may be described as “coupled to” a memory through fabric 710 and cache/memory controller 745. In contrast, in the illustrated embodiment of FIG. 7, graphics unit 760 is “directly coupled” to fabric 710 because there are no intervening elements.

Graphics unit 780 may include one or more processors and/or one or more graphics processing units (GPU's). Graphics unit 780 may receive graphics-oriented instructions, such as OPENGL® or DIRECT3D® instructions, for example. Graphics unit 780 may execute specialized GPU instructions or perform other operations based on the received graphics-oriented instructions. Graphics unit 780 may generally be configured to process large blocks of data in parallel and may build images in a frame buffer for output to a display. Graphics unit 780 may include transform, lighting, triangle, and/or rendering engines in one or more graphics processing pipelines. Graphics unit 780 may output pixel information for display images.

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and/or low-power always-on functionality, for example. I/O bridge 750 may also include interfaces such as pulse-width modulation (PWM), general-purpose input/output (GPIO), serial peripheral interface (SPI), and/or inter-integrated circuit (I2C), for example. Various types of peripherals and devices may be coupled to device 700 via I/O bridge 750.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
one or more processing elements; and
one or more memories having program instructions stored thereon that are executable by the one or more processing elements to:
receive, from a mobile device via a direct wireless connection, information for a user that includes:
payment information that specifies information for at least one transaction instrument; and
device signature information for the mobile device;
store the received payment information;
transmit, to an authentication system, the received device signature information for the mobile device and device signature information for the apparatus, wherein the authentication system is configured to store previously-transmitted device signature information for the mobile device;
receive an authentication confirmation from the authentication system in response to the transmitting; and
subsequent to the authentication confirmation, perform one or more transactions for the user using the stored payment information.

2. The apparatus of claim 1, wherein the device signature information for the mobile device is based on identification of components of the mobile device, wherein the components include hardware components in the mobile device and software applications installed on the mobile device.

3. The apparatus of claim 2, wherein the device signature information is further based on a private cryptographic key stored on the mobile device.

4. The apparatus of claim 1, wherein the received information further includes: transaction log information, user preference information, and private key information.

5. The apparatus of claim 1, wherein, to store the received payment information, the program instructions are further executable by the one or more processing elements to store the received payment information using multiple different types of memory structures on the apparatus.

6. The apparatus of claim 1, wherein the program instructions are further executable by the one or more processing elements to perform the one or more transactions using the stored payment information without requiring the user to perform any of the following for the at least one transaction instrument: one-time password authentication, entering information for the at least one transaction instrument, card verification value (CVV) authentication, and question-and-answer authentication.

7. The apparatus of claim 1, wherein the authentication confirmation is based on login information input by the user to the apparatus for an account associated with the mobile device.

8. The apparatus of claim 1, wherein the apparatus is a mobile device, further comprising:
an antenna; and
a radio configured to communicate via the direct wireless connection using the antenna.

9. A non-transitory computer-readable medium having instructions stored thereon that are executable by a first mobile device to perform operations comprising:
receiving, from a second mobile device via a short-range wireless connection, information for a user that includes:
payment information that specifies information for at least one transaction instrument;
device signature information for the second mobile device;
storing the received payment information;
transmitting, to an authentication system, the received device signature information for the second mobile device and device signature information for the first mobile device, wherein the authentication system is configured to store previously-transmitted device signature information for the second mobile device;
receiving an authentication confirmation from the authentication system in response to the transmitting; and
subsequent to the authentication confirmation, performing one or more transactions for the user using the stored payment information.

10. The non-transitory computer-readable medium of claim 9, wherein the device signature information for the second mobile device is based on identification of hardware components in the second mobile device.

11. The non-transitory computer-readable medium of claim 9, wherein the device signature information for the second mobile device is based on identification of software application installed on the second mobile device.

12. The non-transitory computer-readable medium of claim 9, wherein the performing the one or more transactions using the stored payment information does not require the user to perform any of the following for the at least one transaction instrument: one-time password authentication, entering information for the at least one transaction instrument, card verification value (CVV) authentication, and question-and-answer authentication.

13. A non-transitory computer-readable medium having instructions stored thereon that are executable by a computing device to perform operations comprising:
determining device signature information for the computing device; and
transmitting, to a mobile device via a direct wireless connection, information for a user that includes:
payment information that specifies information for at least one transaction instrument; and
the device signature information for the computing device;
wherein the information is usable by the mobile device to transmit, to an authentication system, the device signature information for the computing device and device signature information for the mobile device, in order to perform authentication with the authentication system for one or more transactions for the user using the payment information.

14. The non-transitory computer-readable medium of claim 13, wherein the determining the device signature information is based on identification of hardware components currently included in the computing device and identification of software applications currently installed on the computing device.

15. The non-transitory computer-readable medium of claim 13, wherein the operations further comprise receiving an authentication confirmation from the authentication system that generated based on whether stored device signature information for the computing device matches received device signature information for the computing device.

16. The non-transitory computer-readable medium of claim 13, wherein the operations further comprise selecting the payment information, from among payment information for multiple different transaction instruments, based on user input.

17. A method, comprising:
storing device signature information for a first mobile device of a user;
receiving an authentication request that includes device signature information for the first mobile device and device signature information for a second mobile device;
determining whether the received device signature information for the first mobile device matches the stored device signature information for the first mobile device; and
based on the determining:
storing the device signature information for the second mobile device and associating the device signature information for the second mobile device with an account of the user, and
authorizing one or more transactions of the user that are initiated using the second mobile device.

18. The method of claim 17, further comprising:
authenticating login information received for the account in the authentication request.

19. The method of claim 17, wherein the device signature information for the first mobile device is generated by hashing multiple values, wherein ones of the multiple values are determined based on hardware components of the first mobile device.

20. The method of claim 17, wherein the authentication request further comprises payment information transferred from the first mobile device to the second mobile device via a direct wireless connection.
